(19) United States
(12) Patent Application Publication
(10) Pub. No.: US 2024/0362701 A1
(43) Pub. Date: Oct. 31, 2024

(54) VIRTUAL REALITY DRESSING ROOM

(71) Applicant: Micron Technology, Inc., Boise, ID (US)

(72) Inventor: Alyssa Scarbrough, Boise, ID (US)

(21) Appl. No.: 18/639,415

(22) Filed: Apr. 18, 2024

Related U.S. Application Data
(60) Provisional application No. 63/462,298, filed on Apr. 27, 2023.

(51) Int. Cl. G06Q 30/0601; G06Q 30/0282

(52) U.S. Cl. CPC G06Q 30/0643; G06Q 30/0282; G06Q 30/0631

(57) ABSTRACT

The present disclosure includes apparatuses, methods, and systems for a virtual reality dressing room. In an example, an apparatus can include a memory device and a processing device communicatively coupled to the memory device. The processing device can receive a first image of a user, receive first input associated with a clothing item via a display in communication with the processing device, provide, via the display, a second image of the clothing item on the user, receive second input associated with the clothing item via the display indicating the user approves the clothing item, and execute instructions to physically provide the clothing item to the user.

### PRIORITY INFORMATION

This application claims the benefits of U.S. Provisional Application No. 63/462,298, filed on Apr. 27, 2023, the contents of which are incorporated herein by reference.

### TECHNICAL FIELD

The present disclosure relates generally to apparatuses, methods, and systems for a virtual reality (VR) dressing room.

### BACKGROUND

A computing device can be a smartphone, a wearable device, a tablet, a laptop, a desktop computer, or a smart assistant device, for example. The computing device can receive and/or transmit data and can include or be coupled to one or more memory devices.

Virtual reality (VR) can include a computer-generated simulation of a three-dimensional (3D) image or environment that can be interacted within in a seemingly real or physical way by a person using special electronic equipment. Augmented reality (AR) can overlay virtual objects on a real-world (e.g., natural) environment. For example, AR can add a 3D hologram to reality. In some examples, AR can be an interactive experience of a real-world environment where real-world objects are enhanced by computer-generated perceptual information. The AR can mask a portion of the real-world environment and/or add to the real-world environment such that it is perceived as an immersive aspect of the real-world environment. Accordingly, AR can alter a person's perception of a real-world environment.

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random-access memory (DRAM), static random-access memory (SRAM), synchronous dynamic random-access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random-access memory (RRAM), and magnetoresistive random access memory (MRAM), such as spin torque transfer random access memory (STT RAM), among others.

### BRIEF DESCRIPTION OF THE DRAWINGS

FIG. 1A illustrates an example of a VR dressing room in accordance with some embodiments of the present disclosure.

FIG. 1B is a functional diagram representing an apparatus including a processing device in communication with a memory device for use in the VR dressing room in accordance with a number of embodiments of the present disclosure.

FIG. 2 is another functional diagram representing an apparatus including a processing device in communication with a memory device for use in the VR dressing room in accordance with a number of embodiments of the present disclosure.

FIG. 3 is a flow diagram corresponding to a method for selecting and receiving wearable goods via the VR dressing room in accordance with some embodiments of the present disclosure.

### DETAILED DESCRIPTION

The present disclosure includes apparatuses, methods, and systems for a VR dressing room. Dressing rooms, which may also be called locker rooms, fitting rooms, etc. are rooms where users can try on clothing or other wearable items to determine a fit of the item or items before making a purchase. Dressing rooms may be private or semi-private, for example. Users may shop for items in a store and try them on in provided dressing rooms. The user may collect multiple sizes and styles of items to take to the dressing in order to find a desired fit. A user may physically try on numerous items and take several trips to the show room floor to find items that fit, feel, and/or look as desired.

Users may choose to shop online for wearable items. A user may directly buy wearable items from a seller over the Internet using a web browser or a mobile app. The user can find an item or items of interest by searching for colors, sizes, brands, etc. The items may then be shipped to the user, at which point the user can try on the items. If an item is not as desired, the user may return the item, may reorder a new size, fit, color, texture, etc., may purchase a new item, or a combination thereof. The user may wait periods of time between purchasing and receiving items.

In contrast, examples of the present disclosure can provide for a VR dressing room equipped with interactive display screens. A user can use the interactive display screens to find items they are interested in trying on (e.g., clothing, cosmetics, accessories, etc.). The user can preview their selection on the interactive display screens; for instance, the item can be projected onto the user, and the interactive display screens can give visibility to the user from different sides. The projection, in some examples, can include a VR projection, using artificial intelligence (AI), for instance. The user may wear glasses or other items to view the VR projection, or no glasses or other item may be needed to view the VR projection (e.g., the interactive display screens may not require VR glasses).

When a user is satisfied with the VR projection, the user can select items they would like, and the items can be distributed to the user from a storage room (e.g., inventory) connected to the dressing room. The user can then physically try on the garment to ensure the item is as desired (e.g., fit, color, drape, texture, etc.). Such examples can allow for users to virtually try on clothing, users to receive recommendations, retailers to save room by removing a show room floor, give the user visibility to all available products rather than missing something in-store, and/or the retailer can market items to the user (e.g., accessories) for which the user may not have been originally shopping.

Examples of the present disclosure can include and apparatus including a memory device and a processing device communicatively coupled to the memory device. The processing device can be configured to receive a first image of a user, receive first input associated with a clothing item via a display in communication with the processing device, provide, via the display, a second image of the clothing item on the user, receive second input associated with the clothing item via the display indicating the user approves the clothing item, and execute instructions to physically provide the clothing item to the user

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context.

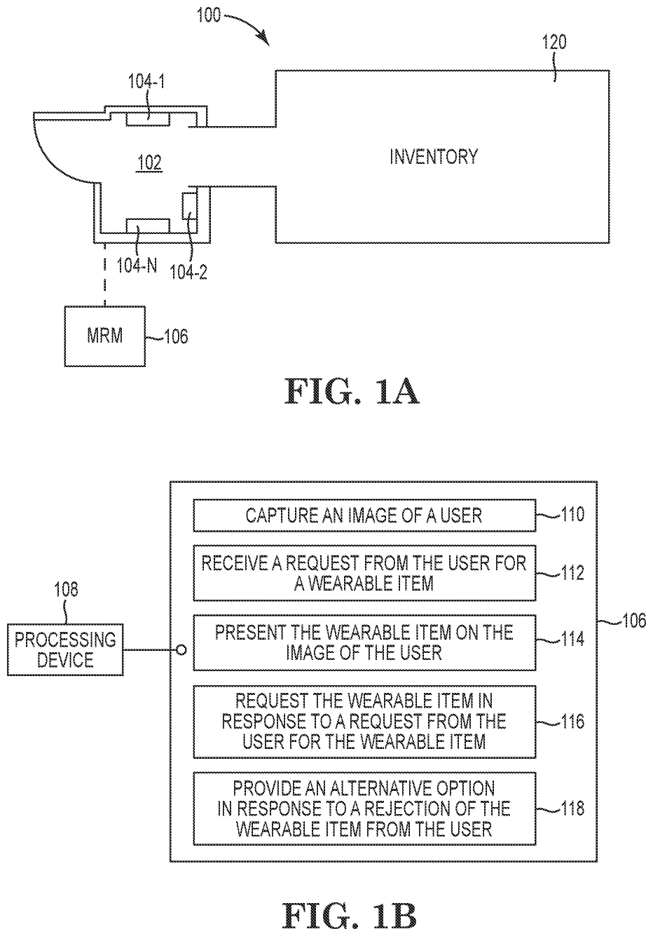

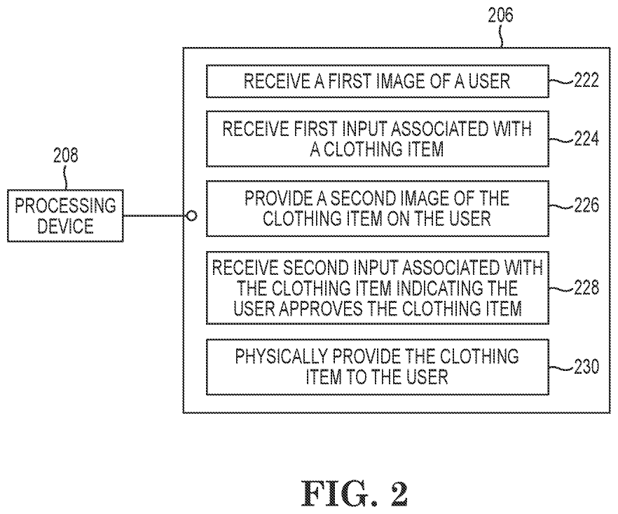

The figures herein follow a numbering convention in which the first digit or digits correspond to the figure number and the remaining digits identify an element or component in the figure. Similar elements or components between different figures can be identified by the use of similar digits. For example, 108 can reference element “08” in FIG. 1B, and a similar element can be referenced as 208 in FIG. 2. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1A illustrates an example of a VR dressing room 100 in accordance with some embodiments of the present disclosure. The VR dressing room 100 can include a first portion 102 and a second portion 120. The first portion 102 can include interactive display screens 104-1, 104-2, 104-N. While three interactive display screens 104 are illustrated in FIG. 1A, more or fewer interactive display screens 104 may be present in the first portion 102 of the VR dressing room 100. The interactive display screens 104 can be generated by a computing device. The interactive display screens 104 can be a graphical user interface (GUI) that can provide and/or receive information to and/or from the user of the computing device (e.g., via MRM 106).

The second portion 120 can be a storage room include inventory. For instance, wearable items such as clothing, hats, shoes, makeup, glasses, accessories, wigs, hair pieces, etc. may be stored in the second portion 120 and available to browse via the interactive display screens 104.

The VR dressing room 100 can include a memory device (e.g., a machine-readable medium (MRM) 106) in communication with a processing device. The memory device can include instructions executable to allow a user to interact with the interactive display screens 104 to determine items to try on. For instance, a user may interact with at least one of the interactive display screens 104 by entering information on what wearable item they are looking for (e.g., shirts, sunglasses, shoes, glasses, jewelry, etc.), and at least one of the interactive display screens 104 may display images of different wearable items that meet some or all of the user's criteria. In some examples, the wearable items may be displayed via the interactive display screens 104 on a model/mannequin or as the wearable item alone.

The user can select a wearable item, and the selected wearable item can be projected onto the user via the interactive display screens 104. The projection may be done utilizing VR, AR, AI, or any combination thereof. If the user is satisfied with the wearable item, the wearable item can be physically distributed to the user from the second portion 120. The user can then feel, inspect, and try on the wearable item. If the user is not satisfied with the wearable item, they may continue to browse via the interactive display screens 104. In some examples, suggestions for other wearable items may be provided to the user. For instance, wearable items having a similar fit, texture, size, design, or accessories that pair with the wearable item with which the user was satisfied. In some examples, the user may pay for desired items via the interactive display screens 104.

FIG. 1B is a functional diagram representing an apparatus including a processing device 108 in communication with a memory device 106 for use in the VR dressing room in accordance with a number of embodiments of the present disclosure. The apparatus illustrated in FIG. 1B can be a server or a computing device (among others) and can include the processing device 108 (e.g., a processing resource). The apparatus can further include the memory device 106 (e.g., a non-transitory MRM), on which may be stored instructions, such as instructions 110, 112, 114, 116, 118. The device, in some examples, may be analogous to the device described with respect to FIG. 2 including processing device 208 and memory device 206. Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory device 106 may be electronic, magnetic, optical, or other physical storage device that stores executable instructions. Thus, the memory device 106 may be, for example, non-volatile or volatile memory. In some examples, the memory device 106 is a non-transitory MRM comprising RAM, an Electrically-Erasable Programmable ROM (EEPROM), a storage drive, an optical disc, and the like. The memory device 106 may be disposed within a controller and/or computing device. In this example, the executable instructions 110, 112, 114, 116, 118 can be “installed” on the device. Additionally, and/or alternatively, the memory device 106 can be a portable, external or remote storage medium, for example, that allows the system to download the instructions 110, 112, 114, 116, 118 from the portable/external/remote storage medium. In this situation, the executable instructions may be part of an “installation package”. As described herein, the memory device 106 can be encoded with executable instructions for finding wearable items based on a user's input and projecting the wearable items onto a user in a VR dressing room via interactive display screens.

The instructions 110, when executed by a processing device such as the processing device 108 can include instructions to capture an image of a user. For instance, the user may enter the first portion of the dressing room and indicate via the interactive display screens that they desire to view wearable items. An image of the user may be captured for use in projecting a wearable item onto the user, as well as for displaying examples of the item on the user via the interactive display screens.

The instructions 112, when executed by a processing device such as the processing device 108 can include instructions to receive a request from the user for a wearable item. For instance, a user may search for a particular wearable item (e.g., cosmetics, clothing item, hats, wigs, shoes, hair accessories, hair extensions, etc.). When the user finds a wearable item with which they are satisfied, the user can interact with an interactive display screen to request the wearable item.

The instructions 114, when executed by a processing device such as the processing device 108 can include instructions to present, via VR and the plurality of interactive display screens, the wearable item on the image of the user. The wearable item may be projected onto the user, and the user can view the virtual or augmented item on themselves via the interactive display screens. For instance, in a dressing room with multiple interactive display screens, a user can see how the projected wearable item looks from multiple angles (e.g., front, back, side). In some examples, the wearable item may be shown to the user as an image on the received image of the user.

In some examples, instructions can be executable to display, via the plurality of interactive display screens, suggestions for additional wearable items based on the request from the user for the wearable item. The suggestions, in some instances, can be based on a fit of the wearable item, the design of the wearable item, the texture of the wearable item, the color of the wearable item, the brand of the wearable item, or any combination thereof. Other factors may be considered when making the suggestion. For instance, if the user requests a shirt, a suggestion for a necklace, pants, or other wearable item that may match the shirt can be provided. In another example, a shirt with a similar design and fit may be suggested to the user. The user may choose to project the suggested wearable item onto themselves or may reject the suggestion.

The instructions 116, when executed by a processing device such as the processing device 108 can include instructions to request, from a second portion of the dressing room, the wearable item in response to a request from the user for the wearable item. For instance, using the previous example, if the user is satisfied with the shirt, they can request the shirt. The physical shirt can be provided to the user from the storage area, and the user can physically try on the shirt. If the user chose to try a suggested wearable item, that, too, can be provided to the user in the VR dressing room.

The instructions 118, when executed by a processing device such as the processing device 108 can include instructions to provide an alternative option via the plurality of interactive display screens in response to a rejection of the wearable item from the user. For instance, if a user does not like the color of the wearable item, the user can enter input via the interactive display screen, and the alternative option can be provided (e.g., a different color wearable item). In some examples, the alternative option can be displayed on the image of the user via the plurality of interactive display screens. For example, before providing the physical alternative wearable item to the user, the alternative wearable item can be projected on the user and/or displayed on the user via the interactive display screens.

In some examples, an AI model can be used to make determinations regarding fit, size, design, etc. of the wearable items, as well as suggestions. The AI model can be trained using user feedback and/or user settings. The AI model can include a plurality of weights, biases, and/or activation functions among other variables that can be used to execute the AI model. The processing device 108 can include components configured to enable the MRM 106 to execute instructions to perform AI operations.

FIG. 2 is another functional diagram representing an apparatus including a processing device 208 in communication with a memory device 206 for use in the VR dressing room in accordance with a number of embodiments of the present disclosure. The memory device 206 can have instructions 22, 224, 226, 228, 230 written thereon. In some examples, the processing device 208 and the memory device 206 comprise a device or apparatus and may be analogous to the processing device 108 and the memory device 106 illustrated in FIGS. 1A and 1B.

The instructions 222, when executed by a processing device such as the processing device 208, can cause the memory device 206 to receive a first image of a user. For instance, the user can enter a dressing room and interact with a display (e.g., an interactive display screen) to begin a dressing room session. The interactive display screen can prompt the user automatically, or the user can initiate the session. Upon initiation, the first image of the user can be captured and received at the memory device 206. In some examples, the first image can be a video image, a still image, a plurality of images (e.g., from different angles), or a combination thereof.

The instructions 224, when executed by a processing device such as the processing device 208, can cause the memory device 206 to receive first input associated with a clothing item via a display in communication with the processing device 208. The display, in some examples, can include a plurality of interactive display screens within a dressing room. For example, the user can provide information via the plurality of interactive display screens regarding desired clothing, colors, fits, sizes, textures, etc. In some instances, the received image, using a machine learning model and or artificial intelligence model, can be utilized to determine a size suggestion for the user and/or in some examples, the processing device can determine, utilizing a machine learning model and/or an artificial intelligence model, a fit of the clothing item on the user (e.g., before, during, or after virtually or physically trying on clothing).

The instructions 226, when executed by a processing device such as the processing device 208, can cause the memory device 206 to provide, via the display, a second image of the clothing item on the user. In some examples, the second image of the clothing item can be displayed on the user via the display (e.g., interactive display screens), VR, AR, projection, etc. For example, if the user via interaction with the display, indicates she would like a blue dress with short sleeves, images of available clothing matching that description can be presented. The user can choose at least one available option to be shown on her, for instance, the dress can be projected on the user, so she can make a decision regarding the option or options.

The instructions 228, when executed by a processing device such as the processing device 208, can cause the memory device 206 to receive second input associated with the clothing item via the display indicating the user approves the clothing item. For instance, the user can indicate she approves of a particular dress or dresses. In some examples, a recommendation can be provided to the user based on the received second input. For example, the user may be shown similar items and/or items that pair with the approved item of clothing. For instance, shoes, necklaces, makeup, hairpieces, etc. may be displayed on the user and/or to the user via the display. The user may indicate whether they would like to virtually and/or physically try on the suggested clothing.

The instructions 230, when executed by a processing device such as the processing device 208, can cause the memory device 206 to execute instructions to physically provide the clothing item to the user. For example, if the user approves of the dress she requested and/or of another recommendation, the item or items may be physically provided to the user. The user may physically try on the item or items to determine whether to purchase the item. The user may continue shopping via the display until she chooses to stop. Additional recommendations may be made to the user based on the acceptance or rejection of the item or items. In some instances, the user can be prompted via the display for a review of the clothing item, and a recommendation can be provided to the user, via the display, based on the review. For example, if the user gives the item a 10 out of 10, suggestions may include similar items or complimentary items, whereas a poor review may result in suggestions of different items.

In some examples, the processing device 208 can cause the memory device 206 to receive input associated with the clothing item via the display indicating the user does not approve the clothing item and execute instructions to not physically provide the clothing item to the user. As noted above, should the user reject the clothing item, for instance because the user does not like the look of the clothing item projected on them, the clothing item is not physically provided to the user. The user may search for other options and/or a recommendation may be made to the user including alternative clothing item options and/or a request for additional input (e.g., what they did or did not like about the rejected item),

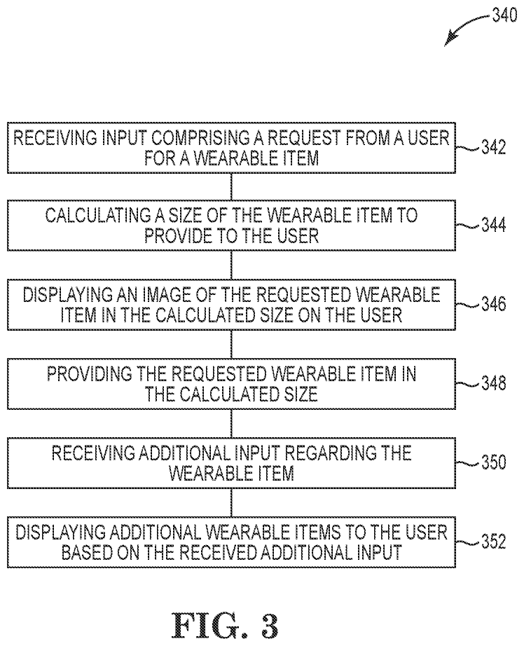

FIG. 3 is a flow diagram corresponding to a method 340 for selecting and receiving wearable goods via the VR dressing room in accordance with some embodiments of the present disclosure. The method 340 may be performed, in some examples, using a computing device such as those described with respect to FIGS. 1B and 2.

At 342, the method 340 can include receiving input, via an interactive display in a dressing room, comprising a request from a user for a wearable item. For instance, a user may enter a dressing room and interact with the interactive display to request particular clothing, shoes, hair (e.g., wigs, extensions, etc.), makeup, accessories, and/or other wearable items. For example, a user may request a “business outfit”, “date makeup”, “active wear”, “swimsuit”, or another wearable item. The user may choose colors, styles, textures, etc. they like or would like to see. The user may enter information about themselves including a typical size worn, height, weight, etc. More or less information may be provided by the user.

The method 340, at 344 can include calculating, using AI and based on the received input, a size of the wearable item to provide to the user. For example, a processing device such as processing devices 108, 208 illustrated in FIGS. 1B and 2 can include components configured to enable a computing device to perform AI operations. In some examples, AI operations may include training operations or interference operations, or both. In a number of embodiments, an AI model can be trained remotely in a cloud using sample data and transmitted to the computing device. In a number of embodiments, data representing wearable item fits, textures, colors, etc. can be stored in memory (e.g., MRMs 106, 206) and/or input into the AI model.

In some examples, user settings can be stored in memory and/or input into the AI model. The user settings can include sizes, preferred fits, preferred textures, height, etc., for example. A size for the user can be determined based on how particular wearable items fit in certain sizes, which may differ between brands, styles, textures, etc.

At 346, the method 340 can include displaying, via the interactive display and virtual reality, an image of the requested wearable item in the calculated size on the user. For instance, an image of the requested wearable item may be illustrated on the interactive display alone, on a model, on an image of the user, and/or projected onto the user via VR or AR. The interactive display may include a plurality of interactive display screens allowing the user to view themselves in the requested wearable item from multiple angles.

The method 340, at 348 can include providing, to the dressing room from a storage location, the requested wearable item in the calculated size. For example, if the user approves of the item, the user may request to see the physical item. A storage room connected to the dressing room may include an inventory of wearable items, and the physical item requested may be provided to the dressing room. In some examples, users are not able to view and/or select items via the interactive display that are not present in the storage location.

At 350, the method 340 can include receiving additional input via the interactive display regarding the wearable item. The user may receive the wearable item and choose to try it on, or they may see or feel the item physically and choose not to. The user can provide the additional input via the interactive display based on their thoughts on the wearable item. For instance, the user may request a different size, different color, different item, coordinating item, etc. The user may also chose to end the session by purchasing the wearable item or indicating they are finished.

The method 340, at 352 can include displaying, via the interactive display, additional wearable items to the user based on the received additional input. For instance, if the user decides they would like a different wearable item, a plurality of additional wearable items may be presented to the user. The user can choose one or more items to physically try on, and at least one of the additional wearable items (e.g., chosen by the user) may be provided to the dressing room from a storage location (e.g., inventory).

The method 340, in some examples, can include displaying the additional wearable items responsive to determining via AI, the additional wearable items address the received additional input with respect to size, fit, color, texture, or any combination thereof. For instance, the user may be presented with the same wearable item in a different size, a similar item in a different brand, different colors, textures, accessories, etc. based on the user's initial input and additional input.

In some instances, the method 340 can include collecting payment for the wearable item responsive to a request to purchase the wearable item. Should the user choose to purchase one or more items, payment can be collected via a payment device, using a smart device, or other payment method. In some examples, the interactive display can prompt for payment, and security tags, monitoring, etc. can be removed or deactivated from purchased items once payment is collected.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one.

Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a memory device; and
a processing device communicatively coupled to the memory device, wherein the processing device is configured to:
receive a first image of a user;
receive first input associated with a clothing item via a display in communication with the processing device;
provide, via the display, a second image of the clothing item on the user;
receive second input associated with the clothing item via the display indicating the user approves the clothing item; and
execute instructions to physically provide the clothing item to the user.

2. The apparatus of claim 1, wherein the processing device is further configured to:
receive input associated with the clothing item via the display indicating the user does not approve the clothing item; and
execute instructions to not physically provide the clothing item to the user.

3. The apparatus of claim 1, comprising the processing device configured to provide the second image of the clothing item on the user via virtual reality (VR).

4. The apparatus of claim 1, comprising the processing device configured to determine, utilizing a machine learning model, a fit of the clothing item on the user.

5. The apparatus of claim 1, comprising the processing device configured to provide a recommendation to the user based on the received second input.

6. The apparatus of claim 1, comprising the processing device to prompt the user, via the display, for a review of the clothing item.

7. The apparatus of claim 6, comprising the processing device to provide a recommendation to the user, via the display, based on the review.

8. The apparatus of claim 1, wherein the display comprises a plurality of interactive display screens within a dressing room.

9. A dressing room, comprising:
a first portion comprising:
a plurality of interactive display screens in communication with a non-transitory machine-readable medium comprising a processing device in communication with a memory resource having instructions executable to:
capture an image of a user;
receive a request from the user for a wearable item;
present, via virtual reality and the plurality of interactive display screens, the wearable item on the image of the user;
request, from a second portion of the dressing room, the wearable item in response to a request from the user for the wearable item; and
provide an alternative option via the plurality of interactive display screens in response to a rejection of the wearable item from the user; and
the second portion in communication with the non-transitory machine-readable medium and housing the wearable item.

10. The dressing room of claim 9, comprising instructions executable to display, via the plurality of interactive display screens, the alternative option on the image of the user.

11. The dressing room of claim 9, comprising instructions executable to display, via the plurality of interactive display screens, suggestions for additional wearable items based on the request from the user for the wearable item.

12. The dressing room of claim 11, wherein the suggestions for additional wearable items are based on a fit of the wearable item.

13. The dressing room of claim 11, wherein the suggestions for additional wearable items are based on a design of the wearable item.

14. The dressing room of claim 11, wherein the suggestions for additional wearable items are based on a texture of the wearable item.

15. The dressing room of claim 9, wherein the wearable item is a clothing item.

16. The dressing room of claim 9, wherein the wearable item is a cosmetic item.

17. A method, comprising:
receiving input, via an interactive display in a dressing room, comprising a request from a user for a wearable item;
calculating, using artificial intelligence and based on the received input, a size of the wearable item to provide to the user;
displaying, via the interactive display and virtual reality, an image of the requested wearable item in the calculated size on the user;
providing, to the dressing room from a storage location, the requested wearable item in the calculated size;
receiving additional input via the interactive display regarding the wearable item; and
displaying, via the interactive display, additional wearable items to the user based on the received additional input.

18. The method of claim 17, comprising providing, to the dressing room from a storage location, at least one of the additional wearable items.

19. The method of claim 17, comprising displaying the additional wearable items responsive to determining via artificial intelligence, the additional wearable items address the received additional input with respect to size, fit, color, texture, or any combination thereof.

20. The method of claim 17, comprising collecting payment for the wearable item responsive to a request to purchase the wearable item.
